(19) United States
(12) Patent Application Publication
(10) Pub. No.: US 2011/0046976 A1
(43) Pub. Date: Feb. 24, 2011

(54) Integrated Communications System

(76) Inventor: William Theodore Peruzzi, Miami, FL (US)

Correspondence Address: MCANDREWS HELD & MALLOY, LTD, 500 WEST MADISON STREET, SUITE 3400, CHICAGO, IL, 60661, US

(21) Appl. No.: 12/860,686

(22) Filed: Aug. 20, 2010

Related U.S. Application Data
(60) Provisional application No. 61/235,555, filed on Aug. 20, 2009.

(51) Int. Cl. G06Q 50/00; G06Q 30/00; G06Q 10/00

(52) U.S. Cl. 705/2

(57) ABSTRACT

An integrated communication system that is a centralized, web-based structure that facilitates efficient, secure and effective communication between and among users who require secure, and multifaceted communication structures. In a healthcare application, these users may include patients, their next-of-kin, or surrogates; clinicians who care for the patient; other friends and family who care about the patient; and the public. The system may function by making the patient the center of an electronic communication scheme. Others, involved as caregivers or loved ones, may be assigned access to various levels of communication on the basis of role and need. The system allows individuals such as care givers and those receiving care to communicate effectively without concern of invasion of their personal domains, while protecting confidential patient healthcare information and enabling communication using a variety of available communications formats and technologies.

### RELATED APPLICATIONS

This application makes reference to, claims priority to, and claims the benefit of U.S. Provisional Patent Application Ser. No. 61/235,555, entitled “Integrated Communications System” (Attorney Docket 20050US01), filed Aug. 20, 2009, the complete subject matter of which is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Communication among caregivers, patients and significant others is frequently a disjointed and uncoordinated process. This unorganized arrangement creates frustrations and dissatisfaction for both those receiving and those providing care. Attempts to use current electronic communication systems (email, cell phones, etc.) are equally inefficient and generally insecure regarding protected health information.

Current clinical practice patterns among caregivers are becoming increasingly characterized by team approaches, with relatively frequent changes in care giver responsibility (i.e., shift-work). Such patterns have been common in ancillary health care professions, but are now becoming even more prevalent among physicians in clinical specialties that did not previously practice such team approaches. This shift in practice patterns creates even greater difficulty when superimposed upon the disjointed communication prevalent in healthcare today.

There are presently individual methods of communication, such as face-to-face appointments, telephonic communication, email, text messaging, etc., that permit communication, but no central process that permits this communication to be accomplished in an organized and secure fashion among multiple users/entities.

### SUMMARY OF THE INVENTION

The present integrated communication system is a centralized, web-based structure (platform) that can facilitate and encourage efficient, effective communication between and among: i) patients, their next-of-kin, or surrogates; ii) clinicians (physicians, nurses, therapists and other caregivers) who care for the patient; iii) other friends and family who care about the patient; and iv) the public, should the patient choose, for example, to share what they consider to be important aspects of their healthcare experience.

The present integrated communication system functions by making the patient the center of an electronic communication scheme. All others, involved as caregivers or loved ones, may be assigned access to various levels of communication on the basis of role and need.

The present integrated communications system provides for a unique assembly of technology that allows secure communication without requiring the exchange of personal and private communication information (i.e., personal phone numbers, personal email addresses, etc.). As such, care givers and those receiving care may communicate effectively without concern of invasion of their personal domains. The inventions described herein can also permit more direct access to care givers by patients, and patients by care givers, on a platform that can keep all abreast of communication that has been received or not received, answered or not answered.

The present integrated communications system is useful to a variety of potential users, including physicians, nurses, ancillary health care professionals, patients, all those interested or involved with the well being of those receiving healthcare. A similar situation exists with veterinary medicine. With regard to other industries (i.e., law, engineering, etc.), all those who require secure, and multifaceted communication structures may benefit from application of the present integrated and secure communication system.

In one embodiment, the present integrated communication system may include a method of facilitating secure communication among patients, their next-of-kin, or surrogates, clinicians who care for the patient, friends and family of the patient, and the public using a healthcare communication system comprising a computer system having at least one processor and memory, the method comprising: assigning a level of access to individuals using the communication system; the individuals including at least one of a patient, the patient's spouse, next-of-kin or surrogate, or the holder of a durable power of attorney for the healthcare of the patient; obtaining patient permission to allow communication between individuals; accepting an incoming message from a sender individual authorized under the patient permission to a recipient individual; processing the message; sending a message notification to the sender individual; and delivering the message to the recipient individual.

In another embodiment, the present integrated communication system is a healthcare communication system having at least one processor and at least one distributed memory for facilitating secure communication among patients, their next-of-kin, or surrogates, clinicians who care for the patient, friends and family of the patient, and the public, wherein: a level of access is assigned to individuals using the communication system, the individuals including at least one of a patient, next-of-kin or surrogate; permission is obtained to allow communication between individuals; an incoming message is accepted from a sender individual authorized under the patient permission to a recipient individual; the message is processed; a message notification is sent to the sender individual; and the message or a modified version of the message is delivered to the recipient individual.

### BRIEF DESCRIPTION OF SEVERAL VIEWS OF THE DRAWINGS

A full and enabling disclosure of the present integrated communication system, including the best mode thereof, directed to one of ordinary skill in the art, is set forth in the specification, which makes reference to the appended figures, in which:

FIG. 1 is a representation of the communication scheme of the present integrated communication system.

FIG. 2 is a representation of the shared communication of the present integrated communication system.

FIG. 3 is a representation of the private communication of the present integrated communication system.

FIG. 4 is a representation of the bridged communication of the present integrated communication system.

FIG. 5 is an overview of the message process associated with the present integrated communication system.

FIG. 6 is a representation of the logic associated with the present integrated communication system.

FIG. 7 is a representation of a physical arrangement of components in one embodiment of the present integrated communications system.

FIG. 8 is a representation of how the present integrated communication system may handle patient privacy issues.

FIG. 9 is a representation of the private versus social communication aspects of the present integrated communication system.

While the present integrated communication system is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

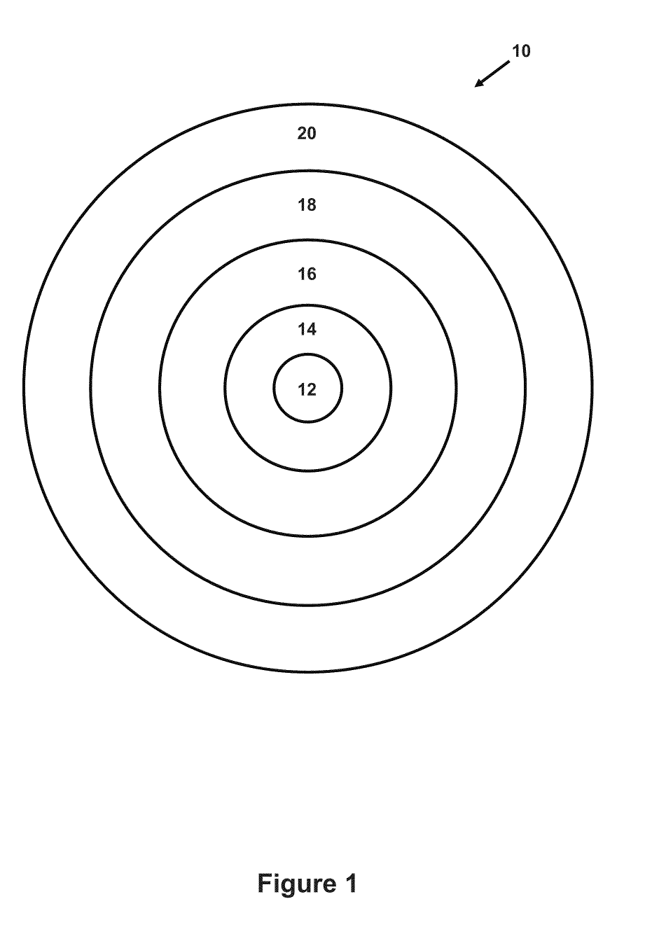

FIG. 1 depicts a communication scheme 10 for the present integrated communication system. As seen in FIG. 1, the platform makes the patient 12 the center of an electronic communication scheme. Of course, if the patient is incapacitated, the patient's surrogate, spouse, or attorney-in-fact may replace the patient as the center of the scheme. All others, involved as caregivers or loved ones, are assigned access to various levels of communication on the basis of role and need. Each progressive ring or level of involvement represents care givers and others associated with the patient in order of decreasing direct influence upon the patient's care. For example, first level 14 is comprised of physicians and physician extenders, e.g. physician assistants, and advanced practitioners. Direct care givers, e.g. nurses, respiratory therapists, etc., and the patient's next of kin or surrogate, e.g. the patient's spouse, the holder of a durable power of attorney for healthcare of the patient, and other decision makers as provided for legally, comprise the next or second level 16. Those family members and friends whom the patient 12 may want to be aware of their course of care comprise a third level 18. Finally, acquaintances and/or the general public may be assigned to a fourth level 20.

Starting with the premise that, with the present integrated communication platform, the patient is the center of function, the patient and/or their surrogate controls the communication streams that may affect their care or involve sharing of protected health care information. Although, in one preferred embodiment, communication processes that are considered protected health information will require patient approval, bidirectional approval will be required when professional relationships are established, at least initially. Approval may be specific to a communication or string of related communications, such as communications relating to a particular ailment or injury, or even body part. Of course, blanket permission may be granted as well.

There can be at least three types of communication available on the platform of the present integrated communication system. Examples of communication types include shared, private and bridged. In a preferred embodiment, the type(s) of communication available will vary depending upon the level of access. There may be many levels of access, including at least the four levels of access described above.

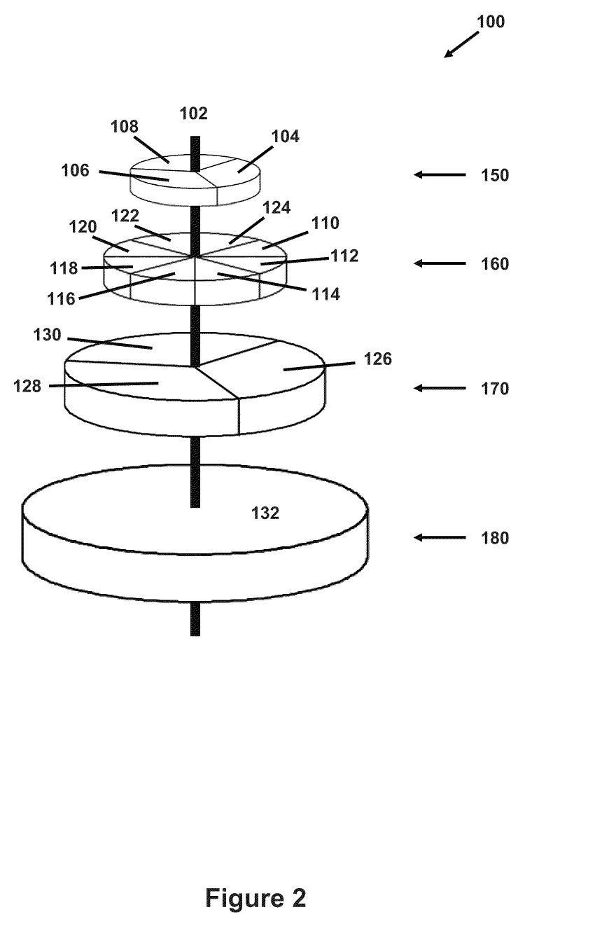

Turning now to FIG. 2, Level I access 150 is restricted to the patient 102, their primary care provider 104, or designee, physicians and physician extenders 106, e.g. physician assistants, and advanced practitioners and consultants, or other designees 108 who are necessary for care delivery. The patient may choose, for example, three types of communication at this level: shared, private or bridged. Information posted at this level may be restricted such that it cannot be copied, forwarded or printed; however, the information may be downloaded to a personal electronic health record or to a hospital or clinical practice electronic medical record.

Level II access 160 includes the patient 102, the patient's spouse or equivalent persons 110, specifically designated surrogates for each of the primary participants, such as the patient's attorney-in-fact, registered or licensed practical nurses 112, physical therapists 114, respiratory therapists 116, occupational therapists 118, physical therapists 120, and speech-language pathologist or therapists 122, and other specified care givers 124, such as pharmacists, etc. Of course, if the patient is incapacitated, the patient's surrogate, spouse, or attorney-in-fact may replace the patient as the center of the scheme. Communication patterns within this level are identical to that of Level I, i.e. shared, private or bridged. Bridging at Level II allows Level I caregivers to view communication threads between the patient 102 and Level II caregiver, but may be restricted such that the Level II caregiver may not be able to view communication threads between the patient 202 and Level I caregivers. However, with proper permissions from, e.g., the patient 102, patient's surrogate and physician and/or physician extenders 106, the Level II caregiver may be able to view communication threads between the patient 202 and Level I caregivers. Bilateral communication among Level I and Level II caregivers may occur, however, in the context of a properly structured electronic medical record. Access granted to Level I caregivers is granted primarily to facilitate understanding of communications or questions between the patient 102 and Level II caregivers. Information posted at this level cannot be copied, forwarded or printed; however, it can be downloaded to a personal electronic health record or to a hospital or clinical practice electronic medical record.

Level III access 170 is provided to the patient 102, surrogates 126, specific caregivers 128 who have patient-granted authority to provide information to family members and friends, collectively 130, who have serious concerns and a need, right or desire to know about the patient. This communication stream is generally one way, from the caregivers out; but concerned family members may post communications that may be viewed by the patient and bridged to specific caregivers when the patient deems appropriate. Information posted at this level may be restricted such that it cannot be copied, forwarded or printed; however, the information may be downloaded to a personal electronic health record or to a hospital or clinical practice electronic medical record.

Level IV access 180 is essentially public and communication streams are open to all, including the patient 102 and friends and acquaintances, collectively 132. This level functions largely as public information website and a public blog. Information posted at this level can be copied, printed or forwarded at will.

The Level IV communication portion 180 could be excluded and the basic purpose of the invention/platform could be maintained. Each access level could function independently, but Level I and Level II could function best to accomplish the goal of effective healthcare communication when operated conjointly.

FIG. 2 depicts shared communication. Shared communication means that all providers granted access may be given access to view all communications that occur within the level. Each “pie piece” in the chart represents an individual with the need, desire or right to communicate with the patient and other care givers. In this illustration, all communication components are fully connected. As such, all individuals are able to see and participate in all communication occurring between the patient and the care givers within their level of access. The patient is represented by the center pole running though all communication levels.

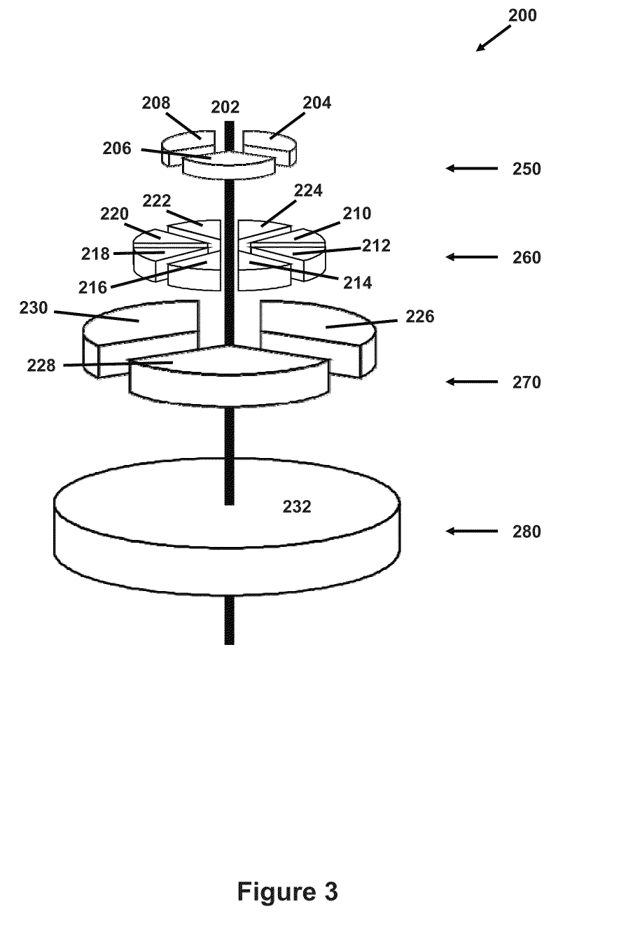

FIG. 3 depicts private communication. Private communication means that communication between the patients and a caregiver can only be viewed by the two parties participating in the communication stream. As in FIG. 2, each “pie piece” in the chart represents an individual with the need, desire or right to communicate with the patient and other care givers. In this illustration, all communication components are fully disconnected. As such, individuals are able to see and participate only in the communication occurring between the patient and the individual care giver. This may be a single communication thread, or multiple communication threads.

Level I access 250 is restricted to the patient 102, their primary care provider 204, or designee, physicians and physician extenders 206, e.g. physician assistants, and advanced practitioners and consultants, or other designees 208 who are necessary for care delivery. The patient may choose, for example, three types of communication at this level: shared, private or bridged. Information posted at this level may be restricted such that it cannot be copied, forwarded or printed; however, it can be downloaded to a personal electronic health record or to a hospital or clinical practice electronic medical record.

Level II access 260 includes the patient 102, the patient's spouse or equivalent persons 210, specifically designated surrogates for each of the primary participants, such as the patient's surrogate, e.g. the patient's attorney-in-fact, registered or licensed practical nurses 212, physical therapists 214, respiratory therapists 216, occupational therapists 218, physical therapists 220, and speech-language pathologist or therapists 222, and other specified care givers 224, e.g. pharmacists, etc. Communication patterns within this level are identical to that of Level I, i.e. shared, private or bridged. Bridging at Level II allows Level I caregivers to view communication threads between the patient 102 and Level II caregiver, but may be restricted such that the Level II caregiver may not be able to view communication threads between the patient 202 and Level I caregivers. However, with proper permissions from, e.g., the patient 102, patient's surrogate and physician and/or physician extenders 106, the Level II caregiver may be able to view communication threads between the patient 202 and Level I caregivers. Bilateral communication among Level I and Level II caregivers may occur, however, in the context of a properly structured electronic medical record. Access granted to Level I caregivers is granted primarily to facilitate understanding of communications or questions between the patient 202 and Level II caregivers. Information posted at this level may be restricted such that it cannot be copied, forwarded or printed; however, the information may be downloaded to a personal electronic health record or to a hospital or clinical practice electronic medical record. While the system may store communication threads, the system preferably does not act as a primary storehouse of medical information, such as electronic medical records.

Level III access 270 is provided to the patient 202, surrogates 226, specific caregivers 228 who have patient-granted authority to provide information to family members and close friends, collectively 230, that have serious concerns and a need/right to know about the patient. This communication stream is generally one way, from the caregivers out; but concerned family members may post communications that may be viewed by the patient and bridged to specific caregivers when the patient deems appropriate. Information posted at this level may be restricted such that it cannot be copied, forwarded or printed; however, the information may be downloaded to a personal electronic health record or to a hospital or clinical practice electronic medical record.

Level IV access 280 is essentially public and communication streams are open to all, including the patient 202 and friends and acquaintances, collectively 232. This level functions largely as public information website and a public blog. Information posted at this level can be copied, printed or forwarded at will. The patient 102 (or, for example, the patient's surrogate if the patient is incapacitated) is represented by the center pole running though all communication levels.

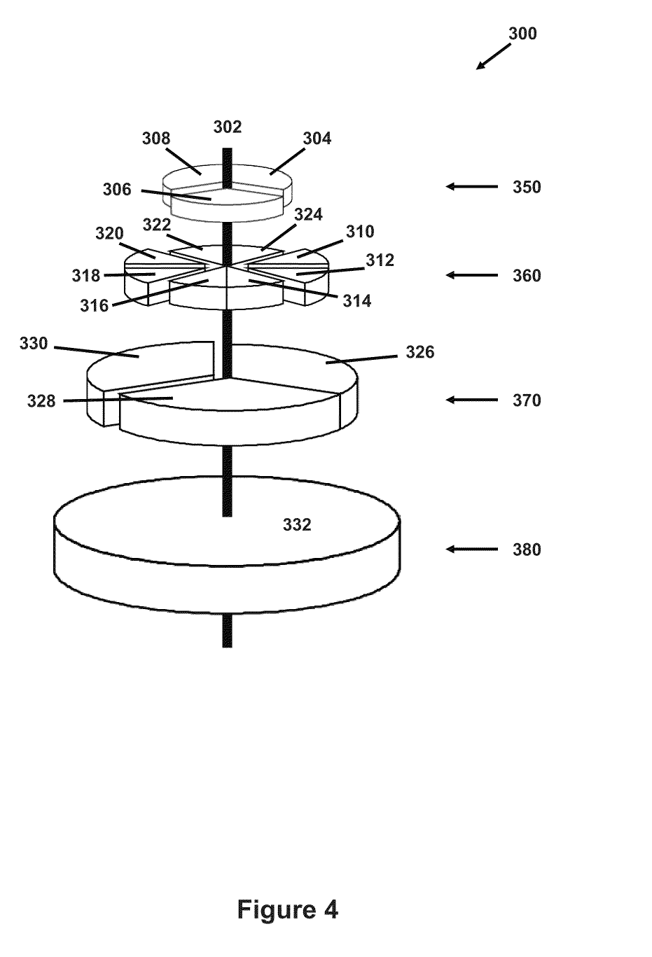

FIG. 4 depicts bridged communication. Bridged communication means that the patient may choose, for example, to permit a variable number of caregivers to view a particular communication thread. Bridging may be extensive and may even result in an effectively shared communication model. Each “pie piece” in FIG. 4 represents an individual with the need, desire or right to communicate with the patient and other care givers. In this illustration, some communication components are fully disconnected and others are connected. As such, connected individuals are able to see and participate in the communication thread occurring between the patient and the other connected care givers or significant others. Private communications may continue between the patient 302 and those not bridged into other communication streams.

Level I is restricted to the patient 302, their primary care provider 304, or designee, physicians and physician extenders 306, e.g. physician assistants, and advanced practitioners, and consultants, or other designees 308 who are necessary for the direction of care delivery. The patient 302 may choose, for example, three types of communication at this level: shared, private or bridged. Information posted at this level may be restricted such that it cannot be copied, forwarded or printed; however, the information may be downloaded to a personal electronic health record or to a hospital or clinical practice electronic medical record.

Level II access 360 includes the patient 302, the patient's spouse or equivalent persons 310, specifically designated surrogates for each of the primary participants, such as registered or licensed practical nurses 312, physical therapists 314, respiratory therapists 316, occupational therapists 318, physical therapists 320, and speech-language pathologist or therapists 322, and other specified care givers 324, e.g. pharmacists, etc. Communication patterns within this level are identical to that of Level I, i.e. shared, private or bridged. Bridging at Level II allows Level I caregivers to view communication threads between the patient 302 and Level II caregiver, but may be restricted such that the Level II caregiver may not be able to view communication threads between the patient 202 and Level I caregivers. Bilateral communication among Level I and Level II caregivers may occur, however, in the context of a properly structured electronic medical record. Access granted to Level I caregivers is granted primarily to facilitate understanding of communications or questions between the patient 302 and Level II caregivers. Information posted at this level may be restricted such that it cannot be copied, forwarded or printed; however, the information may be downloaded to a personal electronic health record or to a hospital or clinical practice electronic medical record.

Level III access 370 is provided to the patient 302, surrogates 326, specific caregivers 328 who have patient-granted authority to provide information to family members and friends, collectively 330, that have serious concerns and a need/right to know about the patient. This communication stream is generally one way, from the caregivers out; but concerned family members may post communications that may be viewed by the patient and bridged to specific caregivers when the patient 302 deems appropriate. Again, information posted at this level may be restricted such that it cannot be copied, forwarded or printed; however, the information may be downloaded to a personal electronic health record or to a hospital or clinical practice electronic medical record.

Level IV access 380 is essentially public and communication streams are open to all, including the patient 302 and friends and acquaintances, collectively 332. This level functions largely as public information website and a public blog. Information posted at this level can be copied, printed or forwarded at will. The patient 302 is represented by the center pole running though all communication levels.

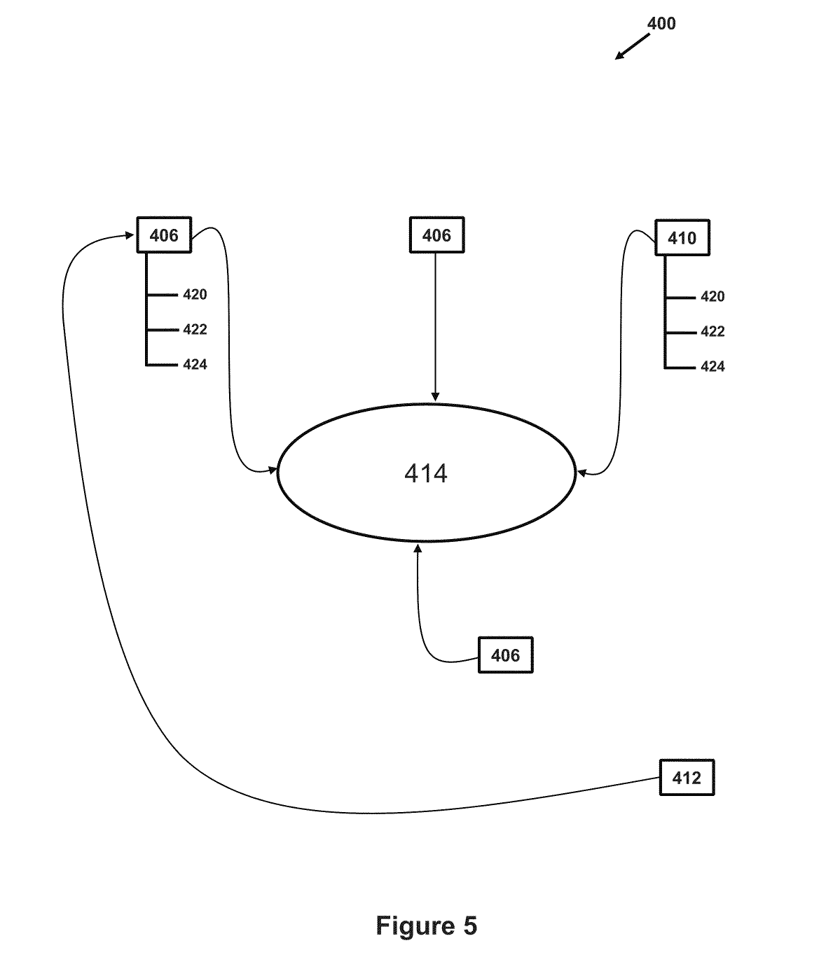

FIG. 5 is a representation of a message process associated with the present integrated communication system. The center oval represents the central server and electronics that comprise the secure website 414. Basically, users may enter messages in the form of an initial message entry step 404 or a reply message entry step 412. Messages may be entered with whatever technology or method the user chooses. For example, messages may be entered using a computer 420, which may in turn enter messages in various formats, e.g. text, voice, video, picture, etc. Messages may also be entered via a Personal Data Assistant (PDA) 422, which may in turn enter messages in various formats, e.g. text, video, picture, etc. Phone 424 messages may also be used to enter a message, which message may be in various formats, e.g. text, voice, video, picture, etc. These message entry devices and their message formats are illustrative examples only, and are not limiting of the present integrated communications system.

Once a message is received, a processing step 406 is performed by the web-based system 400. Processing examples may include translation of the message to other available formats (i.e., voice to text, text to voice, various languages as needed or requested, etc.). A message notification step 408 regarding the message entered may be delivered with whichever technology the users choose, including no notification. A delivery step 410 may then be performed to facilitate delivery to/access by other appropriate users. The delivered message may be received or viewed with the available technology or method the user chooses. For example, messages may be received or viewed using a computer 420, which may in turn receive or view messages in various formats, e.g. text, voice, video, picture, etc. Messages may also be received or viewed via a PDA 422, which may in turn receive or view messages in various formats, e.g. text, video, picture, etc. A phone 424 may also be used to receive or view a message, which message may be received or viewed in various formats, e.g. text, voice, video, picture, etc. These message receiving or viewing devices and their message formats are illustrative examples only, and are not limiting of the present integrated communications system.

The communication platform may permit those receiving care (patient), those who have a personal interest in the individual(s) receiving care (spouse, significant other, surrogate, friends, family, etc.) and healthcare providers to communicate securely in a manner compliant with the Health Insurance Portability and Accountability Act (“HIPAA”), without exchange of private and personal communication information (cell phone numbers, home phone numbers, email addresses, etc.).

Message input (or entry), message processing, notifications regarding message status (entered, processed, delivered, answered, etc.), and message delivery may be managed in various fashions depending upon the personal needs and desires of the users. These processes are diagramed in FIG. 5. Technology exists, and may be integrated into the website, that will allow message input via computer, personal data assistants (PDAs), or telephones via voice, text, video or picture uploads. For example, FIG. 5 shows that message entry 404 may occur via computer, personal data assistants (PDA) or telephone (phone). Once entered, messages may be processed 406 according to their method of entry.

The message processing step 406 may consist of transcription of voice to text, conversion of text to voice, and transcription of the audio portion of video clips (that have audio components) into text messages. Performance of these conversions may allow users to enter and access messages in a fashion with which they are comfortable and for which they have current access. The present integrated communication system may also include the translation of messages from one language to others.

Delivered messages 410 may be accessible by web portal via computer, telephone, or PDA. Typically, however, delivered messages 410 will be contained on the central website servers and will not be transmitted to remote access devices. The website may be structured in such a fashion as to prevent reproduction (i.e., printing, copying) or transmission of the messages (i.e., forwarding, downloading) except to properly structured personal or professional (hospital or practice plan) health information storage systems. In addition, users may be able to view or hear messages in a format of their choice subject to the limitations of the ability to translate the messages (e.g., silent video or pictures typically cannot be converted to text or audio messages unless there is a translation of sign language or the like involved).

Users may be notified of message postings in the message notification step 408, if desired. Notification may be by any means for which the user has registered and selected. Message notification may occur by email, text messaging to phone, voice messaging to phone, facsimile transmission, and instant messaging. In one preferred embodiment, only the status of the message (i.e., posted, received, answered, etc.) will be transmitted to remote access devices, and no protected health information will be transmitted except to bone fide health information storage systems. Users may opt to have no notifications of message status, if desired.

Replies 412 to posted messages may follow the same route as message entry. Messages posted to Level IV, which is essentially a public blog, may not be processed or may be treated differently than messages posted to Levels I-III.

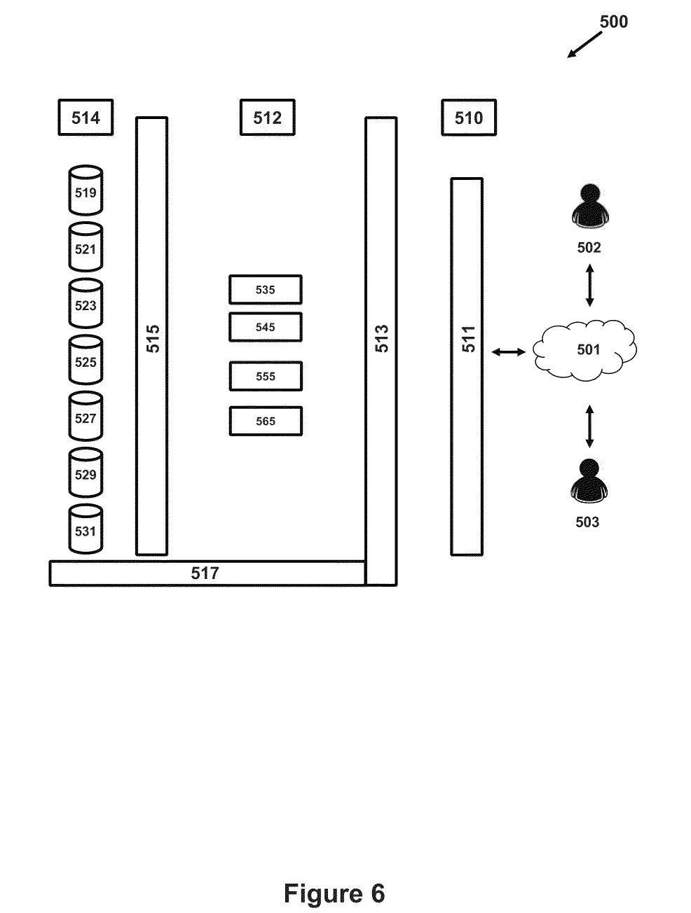

FIG. 6 shows a logical view of the function of the communication system 500. The Internet 501, its users, e.g. a patient 502 and healthcare practitioner 503 access the website via a Web Layer 510. Security applications and tools form a buffer between web layer 510 and Application Layer 512. Application Layer 512 represents the access interfaces to Data Layer 514 through Secured Zone 515. This access may be at a particular access level, e.g. Level I access 535, Level II Access 545, Level III Access 555, or Level IV Access 565. Preferably, the application layer 512 area will be accessible to all.

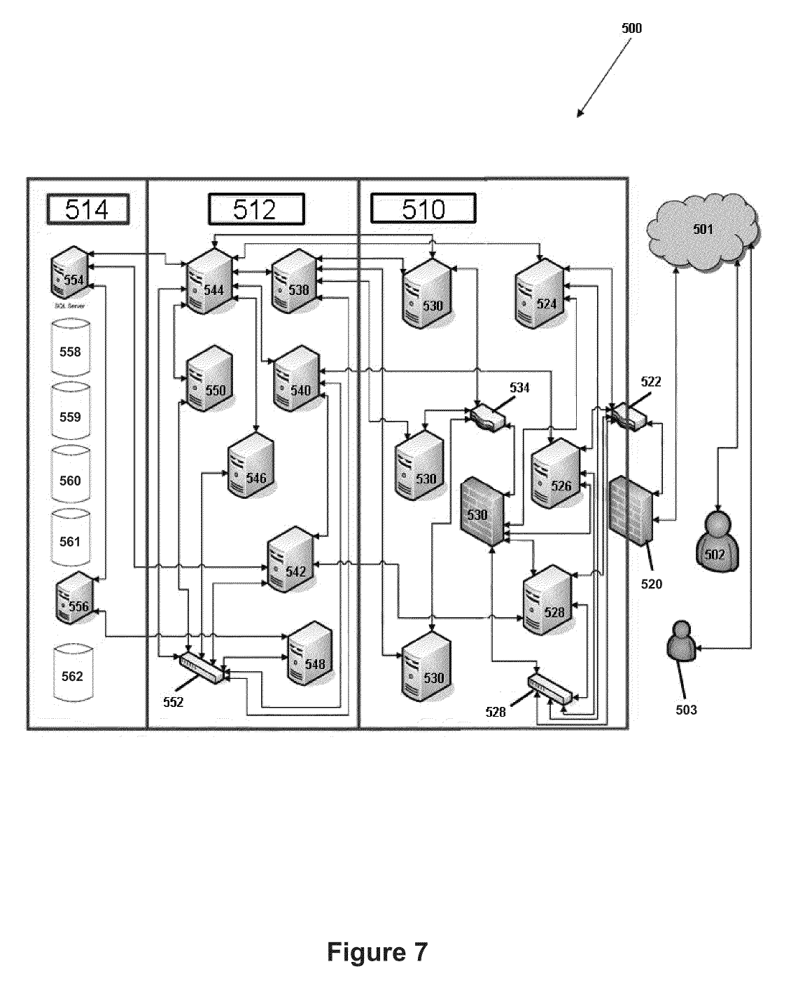

The Data Layer 514 includes operational components as described, e.g., in detail in FIG. 7. These components relate to security scans 517, and the processing and storing of: patient information 519, healthcare provider information 521, e-mail 523, voice mail 525, images 527, video 529, and instant messaging and other text 531. Data layer 514 is housed behind security barriers that can prevent unauthorized access to secure information.

One embodiment of a physical arrangement of components of communication system 500 is depicted in FIG. 7. The components include various processors and memory, which may be distributed memory. Patient medical records, for example, are not stored on system 500, but remain with the patient or other qualified medical record keeper. Working right to left, the Internet 501, its users, including patient 502 and healthcare providers 503, and the tools that may be used to access the website for communication 500 are connected to the web layer 510 through a firewall 520 and router 522, which function as a first layer of defense against attacks on the system. The web layer 510 includes an information rights management server 524 that validates relationships between individuals and content, an e-mail gateway 526 that validates e-mail communications, and a communications gateway 528 that validates message content. These components are connected to web servers 530 through another firewall 532 and router 534. Firewall 532 and router 534, and components to their right in web layer 510 form a second layer of defense against attacks on the system. Web layer 510 also includes a network switch 536.

Web servers 530 are connected to a domain server 538 in application layer 512. E-mail gateway 526 is connected to an e-mail server 540 in application layer 512. Communications gateway 528 is connected to a communications server 542 in application layer 512. A portal server 544 in application layer 512 is connected to domain server 538, the information rights server 524 (located in web layer 510), e-mail server 540, and an integrated voice and response server 546. Application layer 512 also includes at least one backup server 548, a search server 550, and a network switch 552.

Windows Structured Query Language (“SQL”) server 554 in data layer 514 is connected to backup server 548 in application layer 512 via security server 556 in data layer 514. SQL server 554 is also connected to the communications server and the portal server in application layer 512. The above-described servers perform processing and have memory functions.

Data layer 514 also includes databases storing structured data for the system. For example, the system may include a patient-consumer information database 558; a healthcare provider information database 559; an e-mail database 560; a voicemail database 561; an instant messaging database 562; and a video database (not shown).

It should be understood that the physical arrangement depicted in this embodiment is by way of example only, and other arrangements are also possible. Referring generally to FIGS. 6 and 7, the components of the present healthcare communication system may be implemented using combinatorial logic, an ASIC, through software implemented by a CPU, or the like. The communicated information may be stored in registers, RAM, ROM, or the like, and may be generated through software, through a data structure located in a memory device such as RAM or ROM, and so forth.

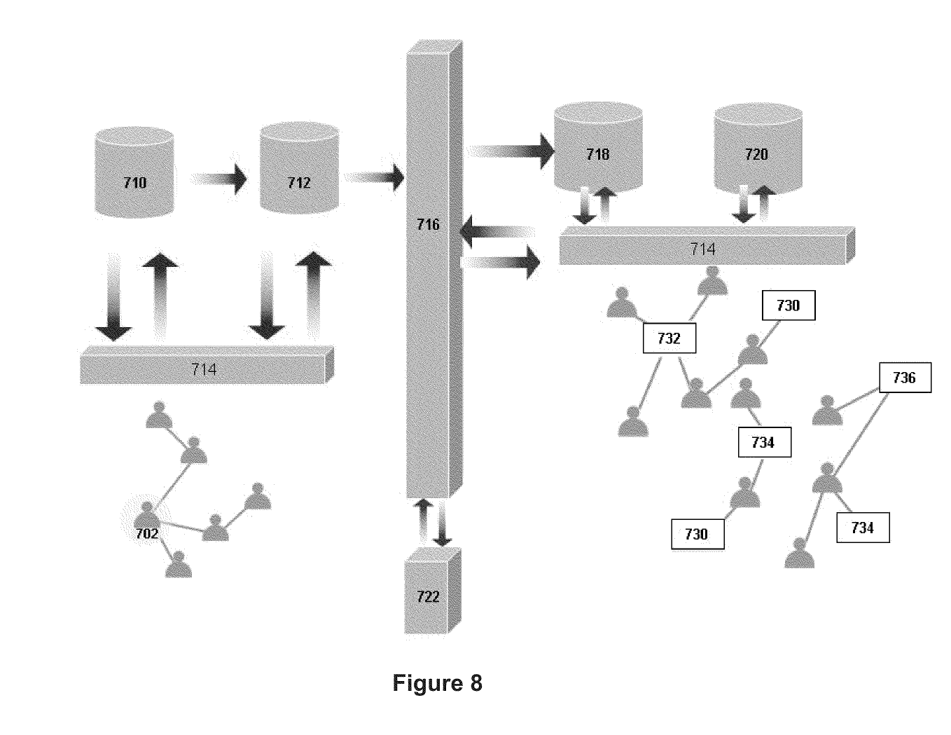

FIG. 8 depicts the logical architecture associated with the private and social layers of the present integrated communications system. The diagrams to the left of the Private-Social Broker 716 represents the private layer, while the diagrams to the right of the Private-Social Broker 716 represents the social layer. The private layer is internal for the patient 702, and therefore may include Level I or Level II communications as depicted by the interconnected figures to the left of Private-Social Broker 716. The social layer is broader, and includes a variety of communications that may span all four levels of access as depicted by the interconnected figures to the right of Private-Social Broker 716. Indeed, the individuals in the social layer are depicted sharing various data 730, 732, 734 and 736 among various individuals.

The privacy metadata layer involves tagging all content across all content types to link to a patient-owner database 710. Patient structured data is uploaded to this database and may then be organized by various methods, e.g. a timeline of an ailment or injury, video, images, medication, X-rays, etc. In the private layer, there is a layer of protection even between the Patient and their specific content (i.e. a piece of content in and of itself cannot be directly linked to the patient, without cross-reference from the privacy meta-data). The present integrated communications system is therefore in an open environment while also accounting for privacy concerns under HIPAA.

Anytime a content is served—either pushed (sent) or pulled (requested)—the system accesses the privacy meta-data database 712 and generates a request that is sent to the owner, requesting permission to serve the content. The permission based engine may accept authorization via at least three methods: e-mail, SMS/mobile messaging and system-messaging (i.e. similar to the built-in e-mail type messaging within a social network). However, if the owner has given permission beyond a single message, e.g. a time, ailment or injury, body part, or individual-based permission, or even a blanket permission for an access level or levels, there may be no need to send such a request.

Private-Social Broker 716 may mask identifying metadata before it is shared to protect private information, such as patient names, phone numbers, and other identifying information, before a recommendation is made for purposes of HIPAA compliance. Private-Social Broker 716 essentially implements privacy rules to maintain the communications of the present integrated communications system HIPAA compliant.

On the social layer side, a Private Network Health Data database 718 stores, e.g., health data provided from providers and private networks. A profile database 720 includes data on providers, such as physicians and other medical professionals. This data may include affiliations, skill sets, etc.

The various databases and individuals of both the patient and social layers are connected to a Pattern Detection and Recommendation application 714 that manages notifications and permissions. The Pattern Detection and Recommendation application 714 is also a search and discovery user interface for the system. In the private layer, the Pattern Detection and Recommendation application searches focus on patient or owner related content. In the social layer, on the other hand, the Pattern Detection and Recommendation application searches expand that focus to include similar content related to others as found in databases 718 and 720.

Pattern Detection and Recommendation application 714 inputs algorithms around designed patterns generated from data in the integrated communications system memory into a pattern-detection engine. Based on these algorithms, the pattern-detection engine then constantly and methodically searches the database to detect patterns in both core content (e.g. original messages, photos, videos) and/or content about the content (e.g. message-conversations about original messages, photos, videos). Based on the searches, certain patterns are detected. These patterns then become the input to a recommendation engine.

The recommendation engine attempts to match the patterns to similar content belonging to Patients or others in the Network (e.g. Physicians). Once a match is found, the recommendation engine may generate a recommendation to the content owner. For example, Patient A posts a content about a certain episode/condition and sends it to physician A and a conversation ensues. A possible scenario would involve the recommendation engine sending an automated recommendation notice to physician A informing Physician A that Physician B has reviewed a similar condition among 5 other Patients, and asking Physician A if he would like to contact Physician B. A similar recommendation can be served to Patients. An opt-in layer may be included so everyone in the network can choose what level of recommendations they can automatically receive (or not). Pattern Detection and Recommendation application 714 is a learning application that builds upon experience as it searches.

A payment gateway 722 may be included in the present integrated communication system so that transactions can automatically be billable, if desired. For example, there may be two options: pre-paid and post-paid. In the pre-paid model, patients pay a certain amount upfront, then for every billable transaction the corresponding amount is deducted from their credit balance. In the post-paid model, all transactions are tracked via a virtual currency points engine. A bill is then sent to the patient on a regular basis, e.g. monthly. The virtual currency points engine is a tracking and reporting system based on the transaction-pricing model.

In the post-paid model, a patient may enroll and deposit a set amount of money. A finite amount of service may be included up-front without deductions from the patient's deposit. For example, the patient may receive five messages to a physician (in every consultation) without charge. Thereafter, the patient will be charged a set fee for each additional message. Pricing may vary by content type. For example, pricing may be higher for commenting on a photo than sending a straightforward text message. With the payment-gateway, all the billing is automated so, as long as the patient agrees to the overall pricing terms and conditions, they can communicate freely and receive a bill afterwards. Bills may be sent to a third-party payer as well.

Alternatively, instead of sending a bill, the system may link to the patient's credit card and charge the card at a pre-determined frequency. For example, the frequency could be shortly after every transaction, at the end of the day of the transaction, or at the end of the month in which the transaction occurred.

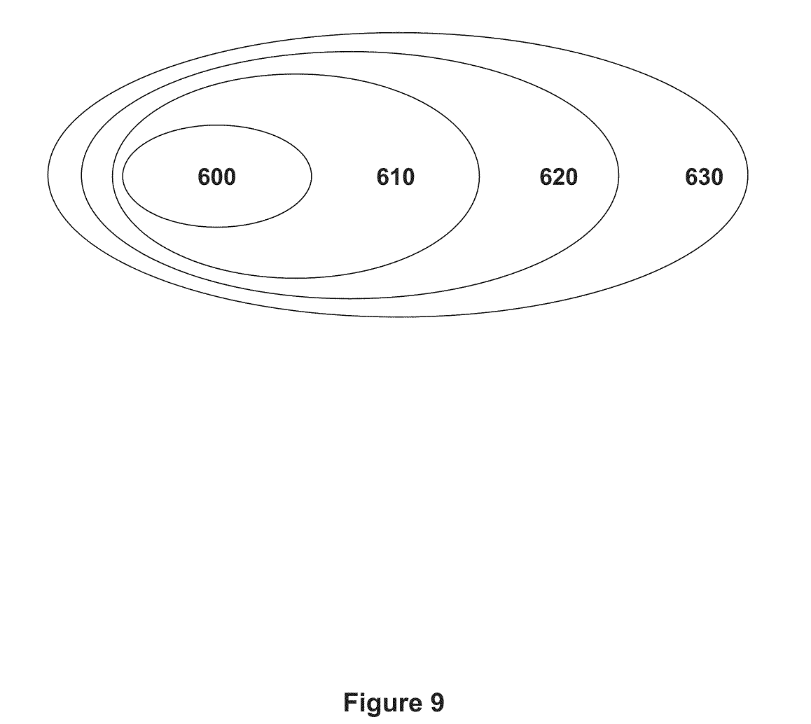

FIG. 9 further describes how the present integrated communication system maintains patient privacy using metadata. Metadata is essentially data about data. Core content metadata 600 includes data about the patient and associated medical information, including the patient's name and other identifying information. What the patient shares is governed by permission and authentication metadata 610, i.e. data about the permission structure of the system and how the patient content 600 data will be authenticated. One example of the permission and authentication structure is as follows: (1) The individual(s) wishing to access patient content 600 sends a message, e.g. an SMS message, to the system requesting access; (2) the patient is notified by the system of the request and either grants or denies permission; if the patient grants permission, the system sends the individual(s) a password to allow viewing of and/or access to the patient content 600, or alternatively enables the individual(s) to use their own password to achieve access. The granted permission may limit access to content based on a variety of restrictions, e.g. date, individual name, content related to a specific ailment or body part, etc.; (3) the individual(s), e.g. the next of Kin along with the patient's doctor, can access the Patient Database, and authentication of the individual(s) identity may utilize a variety of methods, including, for example, biometric verification (including finger or thumbmark verification, retinal or iris scan verification, etc.).

Shared content metadata 620 is shared with the system without revealing identity of the patient. This metadata is data about the sharing of other data, e.g. which data may be shared and with whom. Shared content metadata 620 may be harvested by a bot and stored in a shared content repository. Access to this information will typically be restricted to use within the system, e.g. for creating and comparing message patterns and making recommendations.

Search and discovery metadata 630 is data about whether the core data is searchable, including by a bot. Search and discovery metadata 630 may be structured based on an urgency and relevance algorithm. From the Patient standpoint, the relevance is to match skill-set and expert level for a search criteria. From the physician standpoint, the relevance is based on either research with peers or matching of patient data patterns.

The words used above are words of description rather than of limitation. Although preferred embodiments of the invention have been described using specific terms, devices, and methods, such description is for illustrative purposes only. It should be understood that aspects of the various embodiments may be interchanged both in whole and in part.

For example, the technology that is being supported could employ the products of several companies, including for example, Microsoft, IBM and Oracle, which may supply relational databases, internet connectors, SQL servers and/or web portals useful for employing the present integrated communication system. Web drawing tools, such as Microsoft Visual Studio or Oracle Web by Design, may be employed to implement the present integrated communication system. Collaboration software, such as software from Microsoft Unified Communications, Oracle and/or IBM, may also be useful for employing the present integrated communication system. The present integrated communication system may also employ a web edit and search application, such as Microsoft OSS, Yahoo or Google.

Some components, such as the database technology, could employ lesser service abilities while still maintaining function of the present integrated communication system; however, this would not allow for the maximum ease of configuration and maintenance of the application. In addition, the platform could be constructed to eliminate the various transcription and translation services. However, this may render the platform less versatile and would somewhat inhibit targeted communication processes.

1. A method of facilitating secure communication among patients, their next-of-kin, or surrogates, clinicians who care for the patient, friends and family of the patient, and the public using a healthcare communication system comprising a computer system having at least one processor and memory, the method comprising:
assigning a level of access to individuals using the communication system; the individuals including at least one of a patient, the patient's spouse, next-of-kin or surrogate, or the holder of a durable power of attorney for the healthcare of the patient;
obtaining patient permission to allow communication between individuals;
accepting an incoming message from a sender individual authorized under the patient permission to a recipient individual;
processing the message;
sending a message notification to the sender individual; and
permitting the recipient individual access to the message.

2. The method of facilitating secure communication among patients of claim 1, wherein the patient permission enables shared communication between individuals in an access level.

3. The method of facilitating secure communication among patients of claim 1, wherein the patient permission enables private communication between individuals in an access level.

4. The method of facilitating secure communication among patients of claim 1, wherein the patient permission enables bridged communication between individuals.

5. The method of facilitating secure communication among patients of claim 4, wherein the bridged communication includes individuals in multiple levels of access.

6. The method of facilitating secure communication among patients of claim 1, wherein the step of processing the message comprises at least one of: converting a voice message to a text format; converting a text message to a voice format, converting the audio portion of a video message to a text format; or translating a message into another language.

7. The method of facilitating secure communication among patients of claim 1, wherein the incoming message is in a different format from the delivered message.

8. The method of facilitating secure communication among patients of claim 1, wherein the step of obtaining patient permission further comprises a privacy meta-data layer that cross-references patient information stored on a patient-owner database with meta data stored in a privacy meta-data database.

9. The method of facilitating secure communication among patients of claim 1, wherein a pattern detection engine searches messages associated with a patient detects patterns in the content of those messages, and stores the detected patterns in computer memory; and
a recommendation engine matches existing patterns in messages unrelated to the patient with the detected patterns in the computer memory and sends a recommendation to an individual identifying messages with matching patterns.

10. The method of facilitating secure communication among patients of claim 1, further comprising payment gateway, the payment gateway configured to automatically bill transactions on the communications system.

11. The method of facilitating secure communication among patients of claim 10, wherein the transactions are pre-paid.

12. The method of facilitating secure communication among patients of claim 10, wherein the transactions are post-paid.

13. A healthcare communication system having at least one processor and at least one distributed memory for facilitating secure communication among patients, their next-of-kin, or surrogates, clinicians who care for the patient, friends and family of the patient, and the public, wherein:
a level of access is assigned to individuals using the communication system, the individuals including at least one of a patient, next-of-kin or surrogate;
permission is obtained to allow communication between individuals;
an incoming message is accepted from a sender individual authorized under the patient permission to a recipient individual;
the message is processed;
a message notification is sent to the sender individual; and
the message or a modified version of the message is made accessible to the recipient individual.

14. The system of claim 13, wherein the patient permission obtained enables shared communication between individuals in an access level.

15. The system of claim 13, wherein the patient permission enables private communication between individuals in an access level.

16. The system of claim 13, wherein the patient permission enables bridged communication between individuals.

17. The system of claim 16, wherein the bridged communication includes individuals in multiple levels of access.

18. The system of claim 13, wherein the message processing includes at least one of converting a voice message to a text format, converting a text message to a voice format, converting the audio portion of a video message to a text format, or translating a message into another language.

19. The system of claim 13, wherein the incoming message is in a different format from the delivered message.

20. The system of claim 13, wherein obtaining patient permission further comprises a privacy meta-data layer that cross-references patient information stored on a patient-owner database with meta-data stored in a privacy meta-data database.

21. The system of claim 13, further comprising:
a pattern detection engine, the pattern detection engine configured to search messages associated with a patient, detect patterns in the content of those messages and store the detected patterns in computer memory; and
a recommendation engine, the recommendation engine configured to match the detected patterns with similar patterns associated with other patients in the computer memory, and send a recommendation to an individual identifying the messages having similar patterns.

22. The system of claim 13, further comprising:
a payment gateway, the payment gateway configured to automatically bill transactions on the communications system.

23. The system of claim 22, wherein the transactions are pre-paid.

24. The system of claim 22, wherein the transactions are post-paid.
